(19) United States
(12) Patent Application Publication
(10) Pub. No.: US 2026/0300661 A1
(43) Pub. Date: Oct. 1, 2026

(54) IMAGE FORMING SYSTEM

(71) Applicant: Konica Minolta, Inc., Tokyo (JP)

(72) Inventors: Hokuto HATANO, Tokyo (JP); Daisuke GENDA, Kanagawa (JP)

(21) Appl. No.: 19/576,926

(22) Filed: Mar. 24, 2026

(30) Foreign Application Priority Data
Mar. 28, 2025 (JP) 2025-056431

(51) Int. Cl. G06K 15/02; G06K 15/00; G06T 7/00

(52) U.S. Cl. CPC G06K 15/027; G06K 15/002; G06T 7/0004; G06T 2207/30144

(57) ABSTRACT

An image forming system includes: an image former that forms an image on a recording material based on a print job; a reader that reads the image formed on the recording material; a hardware processor that acquires image quality information by analyzing the read image obtained by the reader, evaluates suitability of image quality based on the image quality information, and adjusts the image former as necessary; a storage that stores, as quality management information, the image quality information in association with adjustment content of adjustment performed by the adjuster; and a display that acquires the quality management information from the storage and displays the quality management information.

### CROSS REFERENCE TO RELATED APPLICATIONS

The entire disclosure of Japanese Patent Application No. 2025-056431 filed on Mar. 28, 2025, is incorporated herein by reference in its entirety.

### BACKGROUND

### Technological Field

The present invention relates to an image forming system.

### Description of Related Art

In an image forming apparatus (a printer, a copying machine, a facsimile, or the like) using an electrophotographic process technology, a uniformly charged photoreceptor is irradiated with (exposed to) laser light based on image data, so that an electrostatic latent image is formed on a surface of the photoreceptor. Next, toner is supplied to the photoreceptor, whereby the electrostatic latent image is visualized as a toner image. After the toner image is transferred to a recording material, the toner image is heated and pressurized in a fixing section. Through the above process, an image is formed on the recording material.

In the related art, an image forming system is known in which an inspection apparatus is provided at a subsequent stage of an image forming apparatus and image stabilization processing is performed based on a read image obtained by the inspection apparatus. In the image stabilization processing, the image on the recording material is read by a reading section of the inspection apparatus, and the obtained read image is analyzed to evaluate the stability of the image quality. When a reduction in image quality is detected in an analysis result of the read image, image formation conditions are adjusted (see, for example, Patent Literature 1 (Japanese Unexamined Patent Publication No. 2018-42161)). A decrease in image quality is determined, for example, based on a deviation of an image density, an image position, or the like from a target value.

In recent years, in order to achieve stable operation and reduction in downtime of an image forming apparatus, there has been a demand from a user to analyze factors that cause image quality degradation and to take a fundamental approach in particular against continuous factors. However, in the conventional image forming system, when the image quality is deteriorated, only the image formation condition is appropriately adjusted inside the image forming apparatus, and the cause of the image quality deterioration is not analyzed.

### SUMMARY

Objectives of the present invention include providing an image forming system capable of improving image quality by efficiently eliminating factors causing deterioration in image quality and improving productivity.

In order to achieve at least one of the above-mentioned objectives, an image forming system reflecting one aspect of the present disclosure includes:

an image former that forms an image on a recording material based on a print job;

a reader that reads the image formed on the recording material;

an analyzer that acquires image quality information by analyzing the read image obtained by the reader;

an evaluator that evaluates suitability of image quality based on the image quality information;

an adjuster that adjusts an image formation condition as necessary;

a storage that stores, as quality management information, the image quality information in association with a content of adjustment performed by the adjuster; and

a display that acquires the quality management information from the storage and displays the quality management information.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically illustrating an overall configuration of image forming system;

FIG. 2 is a diagram illustrating a main part of a control system of the image forming system;

FIG. 3 is a flowchart illustrating an example of image stabilization processing at the start of a print job;

FIGS. 4A and 4B are diagrams illustrating an example of an inspection test pattern output in image stabilization processing at the start of a print job;

FIG. 5 is a flowchart illustrating an example of image stabilization processing during execution of a print job;

FIG. 6 is a diagram illustrating an example of an inspection test pattern to be output in image stabilization processing during execution of a print job;

FIG. 7 is a diagram illustrating an example of a data configuration of quality management information; and

FIG. 8 is a view illustrating an example of a display screen of quality management information.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, an embodiment of the present invention will be described in detail with reference to the drawings.

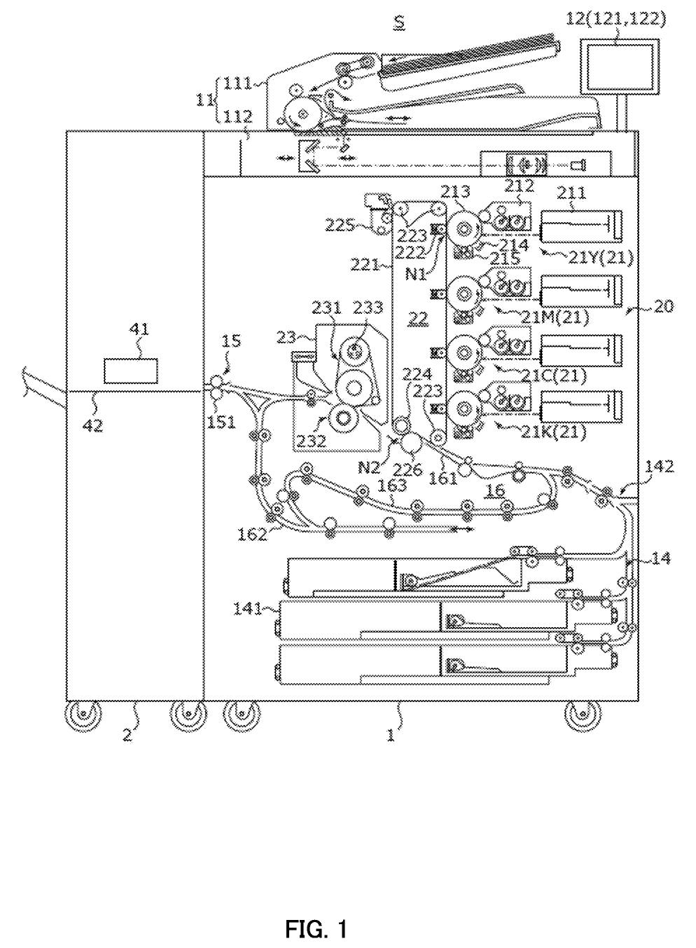

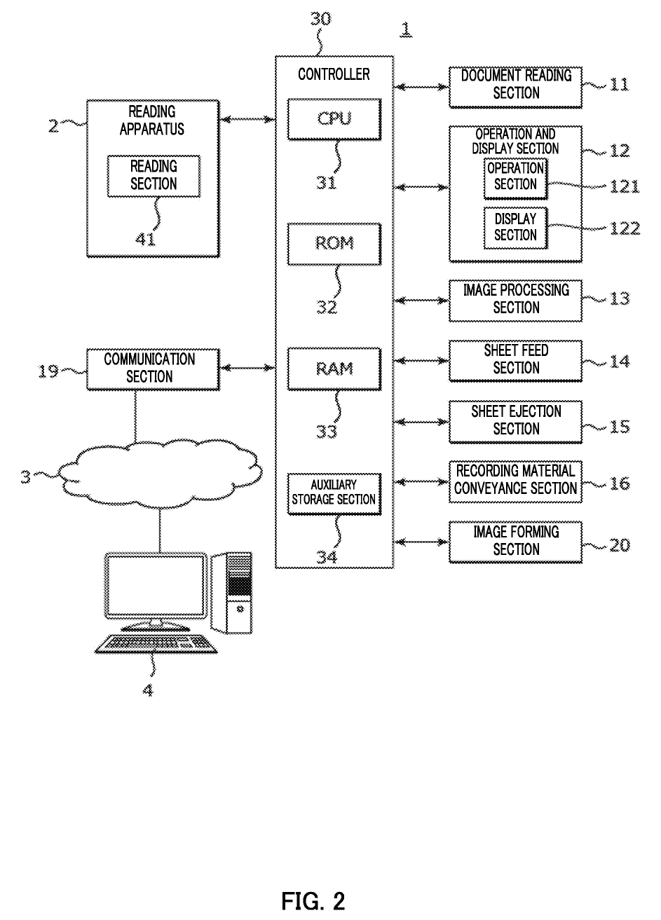

FIG. 1 is a diagram schematically showing an overall configuration of an image forming system S according to an embodiment. FIG. 2 is a diagram illustrating a main part of a control system of the image forming system S. As illustrated in FIGS. 1 and 2, the image forming system S includes an image forming apparatus 1 and an inspection apparatus 2.

The image forming apparatus 1 is an intermediate-transfer-method color image forming apparatus utilizing an electrophotographic process technology. The image forming apparatus 1 primarily transfers toner images of respective colors of yellow (Y), magenta (M), cyan (C), and black (K) formed on the respective photosensitive drums 213 onto the intermediate transfer belt 221. Furthermore, the image forming apparatus 1 superimposes the toner images in four colors on the intermediate transfer belt 221, and then secondarily transfers the toner images onto a recording material, thereby forming an image. The recording material includes a sheet and resin film.

In the present embodiment, a vertical tandem system is adopted for the image forming apparatus 1. In the vertical tandem system, the photosensitive drums 213 corresponding to the four colors of CMYK are arranged in series along the traveling direction (vertical direction) of the intermediate transfer belt 221, and toner images of the respective colors are sequentially transferred to the intermediate transfer belt 221 in one procedure.

The image forming apparatus 1 includes a document reading section 11, an operation and display section 12, an image processing section 13, a sheet feed section 14, a sheet ejection section 15, a recording material conveyance section 16, a communication section 17, an image forming section 20, and a controller 30. The image forming section 20 includes an image forming section 21, an intermediate transfer section 22, and a fixing section 23.

The controller 30 performs overall control of the image forming apparatus 1 by controlling the document reading section 11, the operation and display section 12, the image processing section 13, the sheet feed section 14, the sheet ejection section 15, the recording material conveyance section 16, the communication section 17 and the image forming section 20 in accordance with their respective functions. Furthermore, the controller 30 cooperates with a controller (not illustrated) of the inspection apparatus 2 to control the operation of the reading section 41.

The controller 30 includes a Central Processing Unit (CPU) 31 as an arithmetic/control unit (processor), a Read Only Memory (ROM) 32 and a Random Access Memory (RAM) 33 as main storage devices, and the like. The controller 30 may include an auxiliary storage section 34 constituted by a nonvolatile semiconductor memory (so-called flash memory) such as a Hard Disk Drive (HDD), a Solid State Drive (SSD), or a Secure Digital (SD) card .

A basic program and basic setting data are stored in the ROM 32. A program, a look-up table, and the like, which are read out when the operation of each block is controlled, are stored in ROM 32. The CPU 31 reads a program according to processing contents from the ROM 32, loads the program into the RAM 33, and executes the loaded program, thereby controlling an operation of each functional block of the image forming apparatus 1 and the inspection apparatus 2.

In the present embodiment, the hardware constituting the functional blocks and the controller 30 operate in cooperation with each other, thereby implementing the functions of the functional blocks. Note that the functions of some or all of the functional blocks may be implemented by the controller 30 executing a program. In addition, some or all of the processes executed by the controller 30 may be executed by an electronic circuit provided according to the processes. The electronic circuit includes, for example, a Digital Signal Processor (DSP), an Application Specific Integrated Circuit (ASIC), and a Programmable Logic Device (PLD).

The controller 30 exchanges various kinds of data with an external apparatus 4 (e.g., a personal computer) connected to a communication network 3 such as a Local Area Network (LAN) or a Wide Area Network (WAN) via the communication section 17. The communication section 17 is, for example, a communication interface such as a Network Interface Card (NIC), a MOdulator-DEModulator (MODEM), or a Universal Serial Bus (USB). The communication section 17 may include a communication interface for short-range wireless communication such as Near Field Communication (NFC) or Bluetooth(R). The external apparatus 4 is an information processing terminal operated by the user, and examples thereof include personal computers, tablet terminals, and smartphones.

The controller 30 receives, for example, print job data transmitted from the external apparatus 4, and generates input image data based on the received print job data. The print job data is described in a predetermined Page Description Language (PDL). The print job data includes, for example, data of image objects such as graphics and photographs, and data of text objects such as characters and symbols. The generated input image data is temporarily stored in an image memory (not shown).

When executing a print job, the controller 30 sets image formation conditions based on print setting information of the print job. The print setting information includes sheet setting information and print quality information. The image formation conditions are set with reference to, for example, a Look-Up Table (LUT) stored in advance in ROM 32.

Furthermore, the controller 30 performs image stabilization processing. The image stabilization process is a process of automatically adjusting image quality by detecting a change in image quality caused by an environmental change or a use state of the apparatus. The image stabilization processing includes adjustment of image density, adjustment of image position, and elimination of image noise. In the image stabilization processing, the controller 30 functions as an analysis section, an evaluation section, an adjustment section, a storage section, and a causal factor identification section. The image stabilization processing may be performed, for example, during execution of a print job in a case where a large amount of printing is continuously performed, or may be performed at the time of activation of the image forming system S or at the time of start of a print job. Details of the image stabilization processing will be described later.

The document reading section 11 includes an automatic document sheet feed device 111 referred to as Automatic Document Feeder (ADF), a document image scanning device 112, and the like.

The automatic document sheet feed device 111 conveys a document placed on a document tray by a conveyance mechanism and sends the document to the document image scanning device 112. Using the automatic document sheet feed device 111, it is possible to continuously read images of a large number of documents placed on the document tray (including both faces).

The document image scanning device 112 reads a document conveyed from the automatic document sheet feed device 111 onto a contact glass or a document placed on the contact glass. Specifically, the document image scanning device 112 optically scans a document, and reads a document image by forming, on a light receiving surface of an imaging element (e.g., a Charge Coupled Device (CCD)), an image of reflection light from the document. The document reading section 11 generates input image data based on a result of reading by the document image scanning device 112. The generated input image data is temporarily stored in an image memory (not shown).

The operation and display section 12 is configured by, for example, a flat panel display with a touch screen. As the flat panel display, a liquid crystal display, an organic EL display, or the like can be used. The operation and display section 12 includes a display section 121 and an operation section 122.

The display section 121 displays various operation screens, an image state, an operation state of each function, and the like according to a display control signal input from the controller 30.

The operation section 122 includes various operation keys such as a numeric keypad and a start key. The operation section 122 accepts various kinds of input operation by a user and outputs an operation signal to the controller 30. The user can operate the operation section 122 to make settings related to image formation, such as document setting, image quality setting, magnification setting, application setting, output setting, and recording material setting. In addition, the user can cause the display section 121 to display quality management information indicating a change in image quality by operating the operation section 122.

The image processing section 13 includes a circuit and the like that applies digital image processing to input image data in accordance with initial settings or user settings. The image processing section 13 performs, for example, information extraction processing, image conversion processing, image combination processing, image filtering processing, and correction processing. The image forming section 20 is controlled on the basis of the processed image data.

Based on the input image data, the image forming section 21 forms toner images with color toners of a Y component, an M component, a C component, and a K component. The intermediate transfer section 22 transfers the toner images formed by the image forming section 21 onto a recording material. The fixing section 23 fixes the transferred toner images to the recording material.

For example, the image forming section 21 include four image forming sections 21Y, 21M, 21C, and 21K for Y, M, C, and K components, respectively. The image forming sections 21Y, 21M, 21C, and 21K have the same configuration, and therefore, for convenience of illustration and description, common constituent elements are denoted by the same numerals, and when they are distinguished from each other, they are denoted by adding Y, M, C, and K to their numerals. In FIG. 1, reference signs are representatively provided to the constituent elements of the image forming section 21Y for the Y component and the reference signs of the constituent elements of the other image forming sections 21M, 21C, 21K are omitted.

The image forming section 21 includes an exposure device 211, a developing device 212, a photosensitive drum 213, a charging device 214, and a drum cleaning device 215. Although not illustrated, the image forming section 21 may include a discharger for removing residual charge remaining on the surface of the photosensitive drum 213 after the primary transfer.

The photosensitive drum 213 is, for example, a negatively charged Organic Photo-conductor (OPC). The photosensitive drum 213 has a configuration in which, for example, an undercoat layer, a charge generation layer, and a charge transport layer are sequentially stacked on a circumferential surface of a conductive cylindrical body (aluminum tube) made of aluminum.

The charge generation layer is composed of an organic semiconductor containing a charge generating material (e.g., phthalocyanine pigment) dispersed in a resin binder (e.g., polycarbonate). The charge generation layer generates a pair of positive charge and negative charge upon exposure by the exposure device 211. The charge transport layer has a configuration in which a hole transport material (electron-donating nitrogen-containing compound) is dispersed in a resin binder (for example, polycarbonate resin). The charge transport layer transports the positive charges generated in the charge generation layer to a surface of the charge transport layer.

The charging device 214 is composed of, for example, a corona discharge generator such as a scorotron charging device or a corotron charging device. The controller 30 controls the charging bias applying section 181 to apply a charging bias to the charging device 214. The charging bias applying section 181 is, for example, a direct-current power supply circuit. The charging device 214 generates corona discharge by application of a charging bias and uniformly charges the surface of the photosensitive drum 213 to a negative polarity. The surface potential of the photosensitive drum 213 depends on the charging bias.

The exposure device 211 includes, for example, an LED Print Head (LPH). The LPH includes an LED array, an LPH drive section (driver IC), a lens array and the like. The LED array includes a plurality of linearly arranged Light Emitting Diodes (LEDs). The LPH driving section drives the individual LEDs. The lens array forms an image of the light emitted from the LED array on the photosensitive drum 213. One LED of the LED array corresponds to one dot of an image.

The exposure device 211 emits light corresponding to an image of each color component toward the photosensitive drum 213. The positive charges generated in the charge generation layer of the photosensitive drum 213 by irradiation with light are transported to the surface of the charge transport layer, and thus the surface charges (negative charges) on the photosensitive drum 213 are neutralized. Thus, an electrostatic latent image of each color component is formed on the surface of the photosensitive drum 213 due to a potential difference from its surroundings.

The developing device 212 stores developer of each of the color components (e.g., two component developer including toner and carrier), and forms a toner image by visualizing the electrostatic latent image by causing toner of each of the color components to adhere to the surface of the photosensitive drum 213. The controller 30 controls a developing bias application section (not illustrated) to apply a developing bias to a developer bearing member (whose reference numeral is omitted). The developing bias application section is, for example, a direct-current power supply circuit. The developing bias applying section may include an AC power supply circuit in addition to the DC power supply circuit. The developer bearing member is, for example, a developing roller.

A developing bias is applied to the developer bearing member, and an electric field is formed between the photosensitive drum 213 and the developer bearing member. Due to a potential difference between the photosensitive drum 213 and the developer bearing member, the charged toner on the developer bearing member flies to an image portion (exposed portion) on the surface of the photosensitive drum 213 and adheres thereto as normal toner. Thus, the electrostatic latent image on the photosensitive drum 213 is visualized.

The drum cleaning device 215 removes transfer residual toner remaining on the surface of the photosensitive drum 213 after the primary transfer. The drum cleaning device 215 includes a cleaning member such as a drum cleaning blade that abuts against the surface of the photosensitive drum 213. The drum cleaning device 215 is, for example, integrally attached to the image forming apparatus 1 as a photoreceptor unit together with the photosensitive drum 213.

The intermediate transfer section 22 includes an intermediate transfer belt 221, a primary transfer roller 222, a plurality of support rollers 223 and 224, a belt cleaning device 225, a secondary transfer roller 226, and an optical sensor 227.

The intermediate transfer belt 221 is an image bearing member that carries a toner image, and is a transfer target member to which the toner image on the photosensitive drum 213 is transferred. The intermediate transfer belt 221 is formed of an endless belt and wound under tension in a loop between the plurality of support rollers 223. At least one of the plurality of support rollers 223 is constituted by a driving roller, and the other support rollers are constituted by driven rollers. The rotation of the drive roller causes the intermediate transfer belt 221 to travel at a constant speed.

The primary transfer roller 222 is arranged on an inner peripheral surface side of the intermediate transfer belt 221 in a manner facing the photosensitive drum 213 of each color component. The primary transfer roller 222 is brought into pressure contact with the photosensitive drum 213 with the intermediate transfer belt 221 interposed therebetween, thereby forming a primary transfer nip for transferring a toner image from the photosensitive drum 213 to the intermediate transfer belt 221. The controller 30 controls a transfer bias application section (not illustrated) to apply a primary transfer bias to the primary transfer roller 222.

The support roller 223 includes an opposing roller 224 disposed to face the secondary transfer roller 226. The secondary transfer roller 226 is disposed on the outer peripheral surface side of the intermediate transfer belt 221, and is pressed against and brought into contact with the opposing roller 224 with the intermediate transfer belt 221 interposed therebetween. Thus, a secondary transfer nip for transferring the toner image from the intermediate transfer belt 221 to the recording material is formed. The controller 30 controls a transfer bias application section (not illustrated) to apply a secondary transfer bias to the secondary transfer roller 226.

At the primary transfer nip N1, the toner images on the photosensitive drums 213 are sequentially primary-transferred superposedly onto the intermediate transfer belt 221. Specifically, when a primary transfer bias is applied to the primary transfer roller 222, an electric charge having a polarity opposite to that of the toner is applied to an inner peripheral surface side (a side in contact with the primary transfer roller 222) of the intermediate transfer belt 221. The toner image is electrostatically transferred from the photosensitive drum 213 to the intermediate transfer belt 221.

Thereafter, when the recording material passes through the secondary transfer nip N2, the toner image on the intermediate transfer belt 221 is secondarily transferred onto the recording material. Specifically, a secondary transfer bias is applied to the secondary transfer roller 226, so that a charge having a polarity opposite to that of the toner is imparted to a back surface side (a side in contact with the secondary transfer roller 226) of the recording material. The toner image is electrostatically transferred from the intermediate transfer belt 221 to the recording material. The recording material on which the toner image has been transferred is conveyed toward the fixing section 23.

The belt cleaning device 225 includes a belt cleaning blade (no symbol) that comes into sliding contact with the surface of the intermediate transfer belt 221. The belt cleaning device 225 removes transfer residual toner remaining on the surface of the intermediate transfer belt 221 after the secondary transfer.

The fixing section 23 includes an upper fixing section 231, a lower fixing section 232, a heating source 233, a pressure contact/separation section (not shown), and the like. The upper fixing section 231 includes a fixing surface side member disposed on the fixing surface (the surface on which the toner image is formed) side of the recording material. The lower fixing section 232 includes a back surface side support member arranged on a side of a back surface (a surface opposite to the fixing surface) of the recording material. The heat source 233 heats the fixing surface side member. The pressure contact/separation section brings the back side support member into pressure contact with the fixing surface side member.

The recording material on which the toner image has been secondarily transferred and which has been conveyed along a sheet passage route is heated and pressurized when passing through the fixing section 23. Thus, the toner image is fixed to the recording material.

The sheet feed section 14 includes a sheet feed tray 141 and a manual sheet feed section 142. In the sheet feed tray 141, for example, sheets of paper (standard paper, special paper) identified based on the basis weight, size, and the like are stored for each paper type set in advance. A plurality of sheet feed roller sections (whose reference numerals are omitted) are arranged in the sheet feed tray 141 and the manual sheet feed section 142. A large-capacity external sheet feeding apparatus (not shown) can be connected to the manual sheet feed section 142. The external sheet feed device may be capable of feeding a continuous sheet such as a roll sheet, for example. The sheet feed section 14 sends a recording material fed from the sheet feed tray 141 or the manual sheet feed section 142 to the recording material conveyance section 16.

The sheet ejection section 15 includes a sheet ejection conveyance roller section 151. The sheet ejection section 15 ejects the recording material fed from the recording material conveyance section 16 toward the inspection apparatus 2.

The recording material conveyance section 16 includes a main conveyance section 161, a switchback conveyance section 162, a back surface printing conveyance section 163, and a sheet passage route switching section (not illustrated). Part of the recording material conveyance section 16 and, for example, the fixing section 23 may be incorporated into one unit, and detachably attached to the image forming apparatus 1.

The main conveyance section 161 includes a recording material conveyance element that nips and conveys a recording material. The recording material conveyance element includes, for example, a plurality of conveyance roller sections (whose reference numerals are omitted) including a loop roller section and a registration roller section. The main conveyance section 161 conveys a recording material fed from the sheet feed section 14 and passes the recording material to the image forming section 20 (the intermediate transfer section 22 and the fixing section 23). Further, the main conveyance section 161 conveys the recording material sent from the image forming section 20 (fixing section 23) toward the sheet ejection section 15 or the switchback conveyance section 162.

The switchback conveyance section 162 temporarily stops the recording material sent from the fixing section 23, reverses the conveyance direction, and conveys the recording material to the sheet ejection section 15 or the back surface printing conveyance section 163.

The back surface printing conveyance section 163 recirculates and conveys the recording material switched back by the switchback conveyance section 162 to the main conveyance section 161. The recording material is passed through the main conveyance section 161 in a state where the back surface is an image formation surface.

The sheet passage route switching section (not illustrated) is arranged on the downstream side of the fixing section 23 in the recording material conveyance direction. The sheet passage route switching section switches the sheet passage route according to whether the recording material sent out from the fixing section 23 is ejected as it is, is inverted and ejected, or is conveyed to the back surface printing conveyance section 163. Specifically, the controller 30 controls the operation of the sheet passage route switching section (not illustrated) on the basis of the processing content (single-sided/double-sided printing, face-up/face-down sheet ejection, or the like) of the image formation processing.

The recording material fed from the sheet feed section 14 is conveyed to the image forming section 20 by the main conveyance section 161. Then, when the recording material passes through the secondary transfer section, the toner images on the intermediate transfer belt 221 are collectively transferred onto a first surface (front surface) of the recording material, and a fixing process is performed in the fixing section 23. The recording material on which the image has been formed is ejected to the inspection apparatus 2 by the sheet ejection section 15. In the case where images are formed on both sides of the recording material, the recording material on which the image is formed on the first side is fed to the switchback conveyance section 162. Then, the recording material is reversed by returning to the main conveyance section 161 through the back surface printing conveyance section 163, and an image is formed on the second surface (back surface).

The inspection apparatus 2 is installed at a subsequent stage of the image forming apparatus 1 in the conveyance direction of the recording material. The inspection apparatus 2 is connected to the image forming apparatus 1 via, for example, a dedicated cable (not illustrated). The inspection apparatus 2 includes a reading section 41. The reading section 41 is configured to be able to read an image formed on a recording material conveyed along the conveyance path 42.

The reading section 41 is a so-called scanner. The reading section 41 reads the image on the recording material formed by the image forming section 20 and generates a read image (read image data). The read image is transmitted to the controller 30 of the image forming apparatus 1. The reading section 41 may be configured to be able to read images formed on both sides of the recording material conveyed to the conveyance path 42.

The reading section 41 is a color line sensor capable of reading the range of the entire width in the width direction (main scanning direction) of the recording material. The reading section 41 includes, for example, an LED light source, an optical system, and a sensor array. The LED light source applies laser light to the surface of the recording material passing through the reading section on the conveyance path 42. The optical system forms an image of reflected light from the recording material on the sensor array. The optical system includes a plurality of mirrors, lenses, filters, and the like. The sensor array includes a plurality of optical elements arranged in a line shape along a width direction. Each of the optical elements is, for example, a photodiode, a Charge Coupled Device (CCD), or a Complementary Metal Oxide Semiconductor (CMOS).

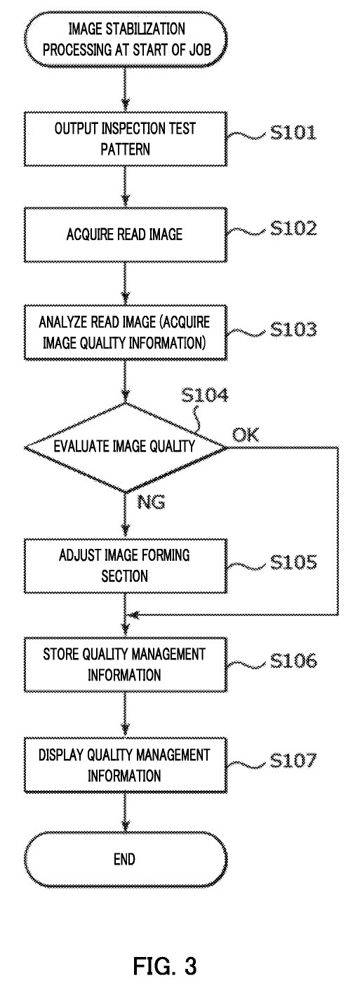

FIG. 3 is a flowchart showing an example of an image stabilization process executed by the controller 30 at the start of execution of a print job. This processing is realized, for example, by the CPU 31 executing the image stabilization processing program stored in the ROM 32 in accordance with the start of execution of the print job.

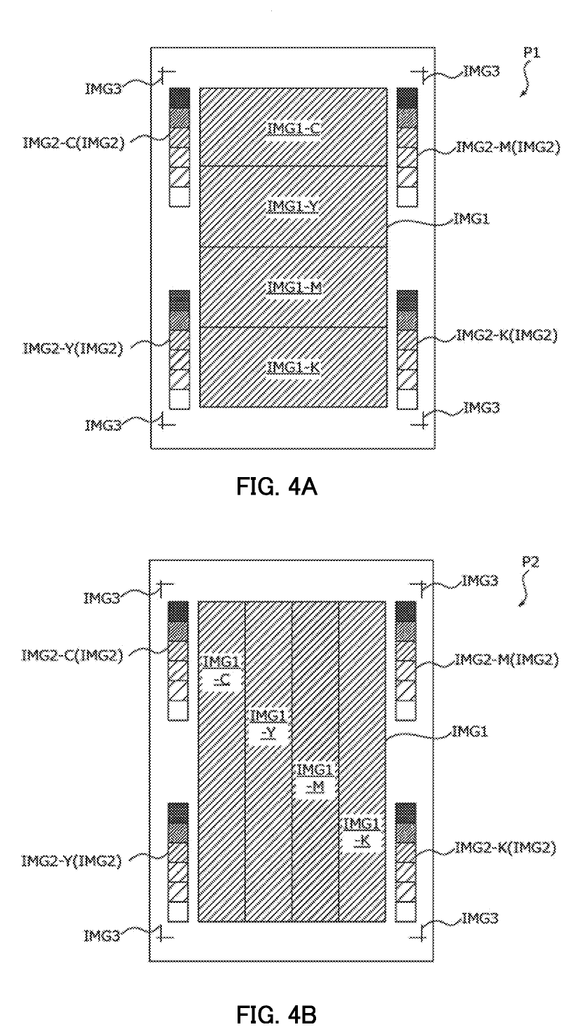

In step S101 of FIG. 3, the controller 30 controls the image forming section 20 to output an inspection test pattern. An example of a test pattern for inspection at the start of the print job is illustrated in FIGS. 4A and 4B. As illustrated in FIGS. 4A and 4B, the inspection test patterns P1 and P2 include halftone images IMG1 of the respective colors, color patch images IMG2, and registration marks IMG3.

Each of the halftone images IMG1 is formed in a main image region of the recording material. The main image region is a region where an image based on image data included in the print job is formed. The halftone images IMG1 include halftone images IMG1-C, IMG1-Y, IMG1-M, and IMG1-K of cyan, yellow, magenta, and black. In FIG. 4A,horizontal-band halftone images IMG1-C, IMG1-Y, IMG1-M, and IMG1-K are formed side by side in the sub-scanning direction (conveyance direction). In FIG. 4B, vertical-band halftone images IMG1-C, IMG1-Y, IMG1-M, and IMG1-K are formed side by side in the main scanning direction.

The halftone image IMG1 can be used to detect an image noise for each color. The image noise includes image streaks, image stains, and spots (color voids). In particular, the halftone image IMG1 in FIG. 4A is suitable for detection of a vertical streak, and the halftone image IMG1 in FIG. 4B is suitable for detection of a horizontal streak.

Each of the color patch images IMG2 is an image in which patches whose density changes stepwise are arranged regularly. The color patch image IMG2 is formed in an end region of the recording material. The end region is a region where the main image is not formed, and that is cut and discarded after image formation and is not used as a product. The color patch images IMG2 include color patch images IMG2-C, IMG2-Y, IMG2-M, and IMG2-K of cyan, yellow, magenta, and black. In the color patch images IMG2-C, IMG2-Y, IMG2-M, and IMG2-K, for example, patches of six gradations are arranged side by side in the sub-scanning direction. The image density of each color can be detected by using the color patch images IMG2.

Each of the registration marks IMG3 is an image serving as a reference for alignment. Registration marks IMG3 are corner register marks arranged at four corners of the recording material. An image position can be detected by using the registration marks IMG3.

In step S102 of FIG. 3, the controller 30 causes the reading section 41 to read the inspection test patterns P1 and P2 formed on the recording material and acquires a read image.

In step S103, the controller 30 analyzes the read image to acquire image quality information (processing as an “analyzer"). The image quality information includes, for example, a deviation amount of image density, a deviation amount of image position, and the presence or absence of image noise.

The deviation amount of the image density is obtained, for example, by comparing the image density (reference value) of the color patch image IMG2 set in the print original data with the image density (analysis value) of the color patch image IMG2 in the read image. The deviation amount of the image position is obtained by, for example, comparing the image position (reference value) of the registration mark IMG3 set in the print original data with the image position (analysis value) of the registration mark IMG3 in the read image. The presence or absence of the image noise is obtained by, for example, comparing the pixel value (reference value) of the halftone image IMG1 set in the print original data with the pixel value (analysis value) of the halftone image IMG1 in the read image.

In step S104, the controller 30 evaluates the suitability of image quality on the basis of image quality information (processing as an “evaluator"). When the image quality is OK, the process proceeds to step S106. When the image quality is NG, the process proceeds to step S105.

The case where the image quality is NG is a case where a decrease in image quality is recognized and adjustment of the image forming section 20 should be performed, and is not a case where an image abnormality that makes a printed material unacceptable for use is detected. In other words, a certain image quality is maintained even if the image quality is determined to be NG, and the printed material can be used as a normal printed material.

Regarding the image density, for example, in a case where a deviation amount of the image density exceeds a predetermined threshold value, it is determined that the image quality has deteriorated. With respect to the image position, for example, in a case where a deviation amount of the image position exceeds a predetermined threshold value, it is determined that the image quality has deteriorated. For image noise, for example, when the difference between pixel values is at an abnormal level, it is determined that the image quality has deteriorated.

In step S105, the controller 30 adjusts the image forming section 20 (processing as an “adjuster"). In the case of image quality reduction due to image density, image formation conditions are adjusted so that the image density falls within an allowable range. The adjustment of the image density includes, for example, adjustments of exposure intensity, a developing bias, and a transfer bias in the image forming section 20. In the case of image quality deterioration due to image position, image formation conditions are adjusted so that the image position falls within an allowable range. The adjustment of the image position includes, for example, position adjustment of the sheet feed tray and conveyance elements (including the conveyance roller and the conveyance belt). In the case of image quality reduction due to image noise, refresh processing for the image forming section 20 is performed so as to eliminate the image noise. The refresh processing for the image forming section 20 includes, for example, cleaning of charging electrodes of the charging device 214 and cleaning and discharging of the photosensitive drum 213.

In step S106, the controller 30 stores the image quality information and the adjustment content in association with each other as quality management information (processing as a "storage"). The quality management information is stored in, for example, the auxiliary storage section 34. By storing the image quality information and the adjustment content in association with each other, the user can confirm the transition of the image quality and the adjustment content later and analyze the causal factor. In addition, the user can easily grasp the presence of the continuous factor, and can efficiently perform maintenance.

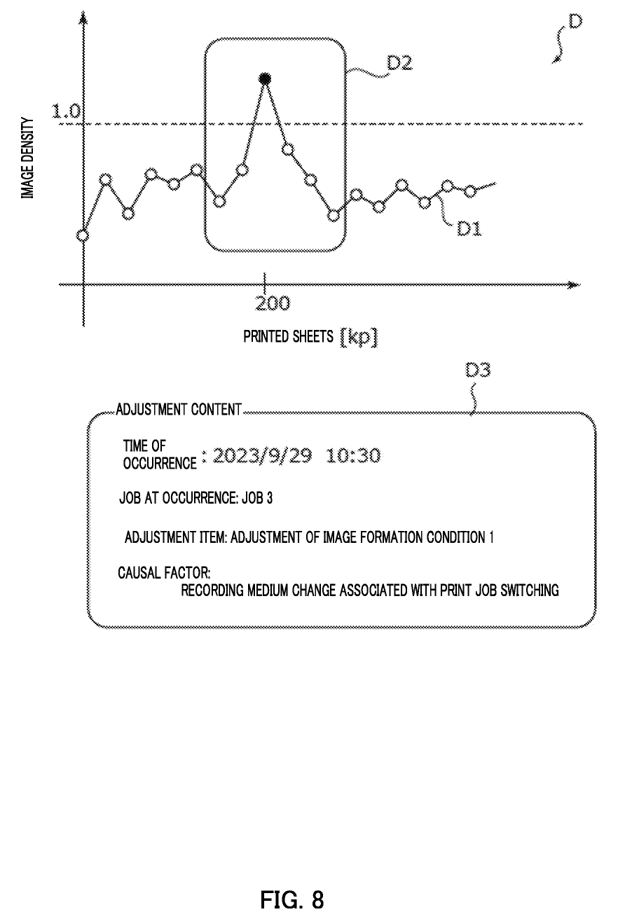

In step S107, the controller 30 generates a stabilization processing history screen (see FIG. 8) based on the quality management information, and causes the display section 121 to display the stabilization processing history screen. The user can easily confirm transition and adjustment contents of the image quality on the stabilization processing history screen. Note that the stabilization processing history screen may be displayed in real time, or may be displayed in response to a user operation on the operation section 122.

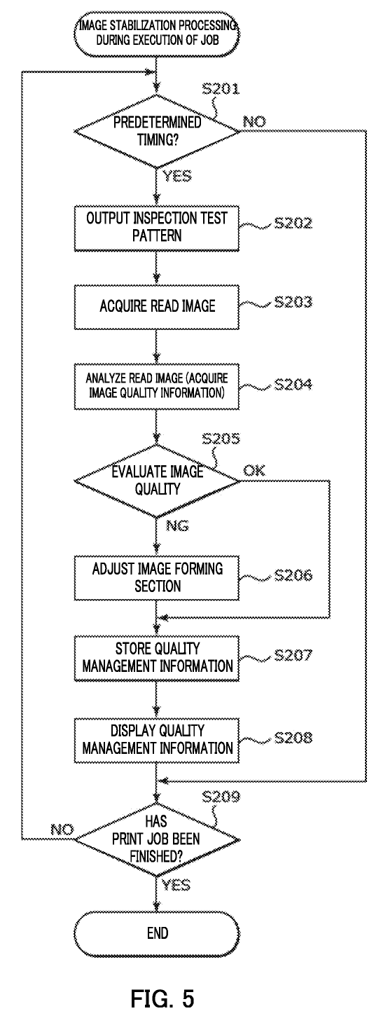

The image stabilization processing at the start of the print job is performed as described above. Subsequently, the image stabilization processing during execution of the print job is performed according to the flowchart illustrated in FIG. 5. The flow of basic processing is the same as that of the flowchart at the start of the print job illustrated in FIG. 3. Overlapping parts will be described briefly.

During execution of the print job, sampling of the image quality information is performed at a predetermined timing. The sampling of the image quality information may be performed for each printing of one sheet, but since a processing load becomes large, it is preferable to appropriately set the sampling in consideration of the processing load and the like. The sampling timing is, for example, once every 20,000 prints every time (per 20 kp).

In step S201 of FIG. 5, the controller 30 determines whether it is a predetermined timing to perform sampling of the image quality information. When it is the predetermined timing ("YES" in step S201), the process proceeds to step S202. When it is not the predetermined timing ("NO" in step S201), the process proceeds to step S209.

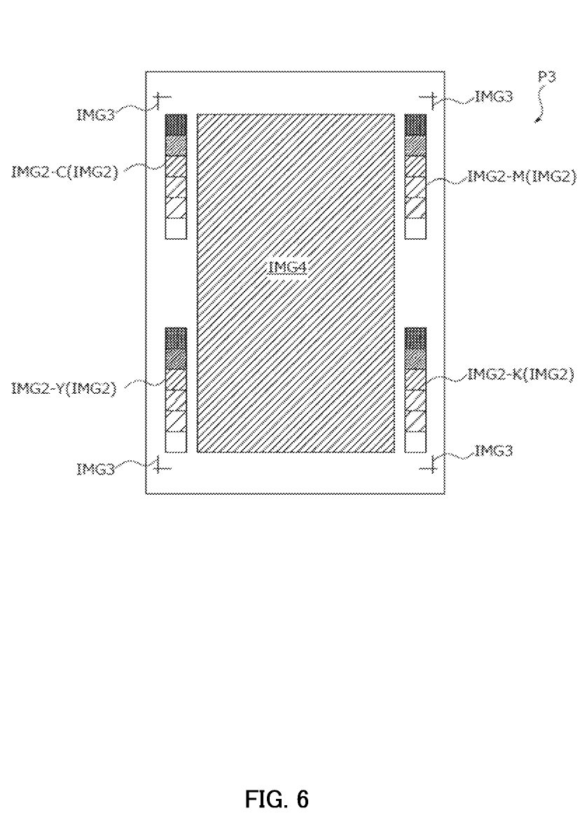

In step S202, the controller 30 controls the image forming section 20 to output an inspection test pattern. An example of the test patterns for inspection during execution of a print job is illustrated in FIG. 6. As shown in FIG. 6, the inspection test pattern P3 includes a main image IMG4, a color patch image IMG2 of each color, and registration marks IMG3. The color patch images IMG2 and the registration marks IMG3 are the same as those of the inspection test patterns P1 and P2 illustrated in FIGS. 4A and 4B. The color patch images IMG2 and the registration marks IMG3 are disposed around the main image IMG4 based on the print job.

Note that the main image based on the print job during execution may be used as the inspection pattern. In this case, it is not necessary to form the color patch images IMG2 and the registration marks IMG3 for inspection. However, in order to increase detection accuracy, it is preferable to use the color patch images IMG2 and the registration marks IMG3 for inspection. Known techniques can be applied to a method of detecting the image density, the image position, and the image noise of the read image.

In step S203, the controller 30 causes the reading section 41 to read the inspection test patterns P3 formed on the recording material, and acquires a read image.

In step S204, the controller 30 analyzes the read image to acquire image quality information (processing as an “analyzer").

In step S205, the controller 30 evaluates the suitability of image quality on the basis of image quality information (processing as an “evaluator"). When the image quality is OK, the process proceeds to step S207. When the image quality is NG, the process proceeds to step S206.

In step S206, the controller 30 adjusts the image forming section 20 (processing as an “adjuster"). In the case of image quality reduction due to image density or image position, image formation conditions are adjusted in the same manner as at the start of the print job. Since certain image quality is maintained as the printed material, there is no hindrance to treating the printed material that has been printed as the normal printed material, and image quality is improved by adjustment of the image formation conditions. In the case of the image quality deterioration due to the image noise, the refresh processing of the image forming section 20 is not performed during the execution of the print job, and for example, the refresh processing of the image forming section 20 is performed between jobs after the print job is finished.

Note that in the case where a significant reduction in image quality is observed in the evaluation results of image density, image position, and image noise, and the printed material cannot be used normally, the execution of the print job may be forcibly interrupted and the image forming section 20 may be adjusted. In addition, the abnormal image removing apparatus may specify and remove the printed material in which the abnormal image is generated. In this case, the number of removed sheets may be adjusted to be compensated for by reprinting.

In step S207, the controller 30 stores the image quality information and the adjustment content in association with each other as quality management information (processing as a "storage"). The quality management information is stored in, for example, the auxiliary storage section 34. By storing the image quality information and the adjustment content in association with each other, the user can confirm the transition of the image quality and the adjustment content later and analyze the causal factor. In addition, the user can easily grasp the presence of the continuous factor, and can efficiently perform maintenance.

In step S208, the controller 30 generates a stabilization processing history screen (see FIG. 8) based on the quality management information, and causes the display section 121 to display the stabilization processing history screen. The user can easily confirm transition and adjustment contents of the image quality on the stabilization processing history screen. Note that the stabilization processing history screen may be displayed in real time, or may be displayed in response to a user operation on the operation section 122.

In step S209, the controller 30 determines whether or not the print job is completed. When the print job is finished ("YES" in step S209), the image stabilization processing is finished. If the print job has not been completed ("NO" in step S209), the process proceeds to step S201.

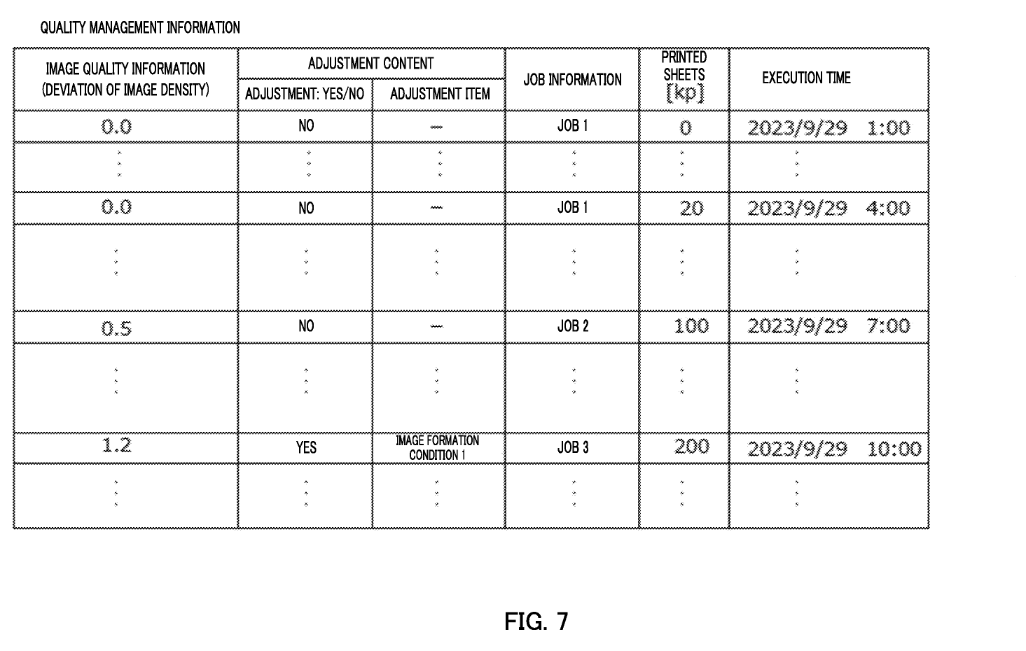

An example of the data structure of the quality management information stored in step S106 of FIG. 3 and step S207 of FIG. 5 is illustrated in FIG. 7. As illustrated in FIG. 7, the quality management information includes image quality information and adjustment content associated with each other. The image quality information and the adjustment content are registered over time together with the number of printed sheets and an execution time when the image stabilization processing is performed.

In FIG. 7, the image quality information is the amount of shift of the image density relative to the reference density. Here, in a case where the deviation amount of the image density exceeds the threshold value "1.0", it is determined that the image quality has deteriorated. The image quality information may include a measured value (analysis value) of image density.

The adjustment content includes presence or absence of adjustment and adjustment items. The adjustment items are adjusted image formation conditions. In the case of adjusting the image density, the adjustment items include, for example, adjustment of exposure intensity, development bias, transfer bias, and the like. When the image position is adjusted, the adjustment items include, for example, the position adjustment of the sheet feed tray and the conveyance elements. The number of adjustment items may be one or more. The adjustment content may include an adjustment value of each image formation condition.

FIG. 7 shows that when the number of printed sheets is 0 kp (at the start of a print job), 20 kp, and 100 kp, the amount of deviation in image density is within the allowable range, and the image qualities are normal, so that the image formation conditions are not adjusted. Further, FIG. 7 shows that the adjustment of the image formation condition 1 is performed because it is determined that the deviation amount of the image density exceeds the threshold value "1.0" at the time when the number of printed sheets is 200 kp.

Furthermore, in the quality management information illustrated in FIG. 8, job information on a print job is associated with the image quality information and the adjustment content. The job information includes various types of setting information related to printing. The job information includes, for example, sheet setting information such as a size, a basis weight, a type, and a direction of a recording material, and designation of a sheet feeding tray. Furthermore, for example, the job information includes quality setting information such as resolution, color setting (color or monochrome), print density, and image quality mode.

Although not illustrated in FIG. 8, apparatus status information may be associated with the image quality information and the adjustment content. The apparatus state information is information indicating an apparatus state that can affect image quality, and is, for example, an actual measurement value acquired by a sensor or the like. The apparatus state information includes an installation state and a driving state of a constituent part. The installation states of the constituent parts are, for example, positions of the sheet feed tray and/or the conveyance element. The driving states of the constituent parts are, for example, the number of rotations, a developing bias voltage, a transfer bias voltage, a fixing temperature, and the like of a rotating body (for example, the photosensitive drum 213). The apparatus state information may include environment information such as temperature and humidity inside the image forming apparatus 1.

Furthermore, the controller 30 may identify a causal factor of image quality deterioration on the basis of the timing at which it is determined that the image quality has deteriorated, the adjustment content, the job information, and the apparatus state information, and may associate the identified causal factor with the image quality information and the adjustment content (processing as "causal factor identification section"). The number of candidates for the causal factor may be one or more. In a case where there are a plurality of candidates for the causal factor, the candidates may be ranked in descending order of possibility.

For example, in a case where the print job is switched before and after the image quality deterioration due to the image density and the type of the recording material is changed, the "change of the recording material" can be identified as one of the causal factors. Furthermore, for example, if the temperature and humidity (an example of the apparatus state information) inside the image forming apparatus 1 has changed before and after the image quality deterioration due to the image density, "change in internal environment" can be identified as one of the causal factors.

In addition, in a case where the print job is switched before and after the image quality deterioration due to the image position and the sheet feeding tray is changed, it is possible to identify the "change of the sheet feeding tray" as one of the causal factors. Furthermore, if the position of the sheet feed tray (an example of the apparatus state information) has been changed between before and after the image quality deterioration due to the image position, "position change of the sheet feed tray" can be identified as one of the causal factors. The position of the sheet feed tray may be changed due to, for example, vibration during operation of the apparatus.

The above-described causal factor is a temporary factor associated with switching of a print job or a change in an apparatus state. On the other hand, the deterioration of the constituent parts with time is a continuous factor which cannot be eliminated by the adjustment of the image formation conditions or the refresh processing of the image forming section 20. For example, during execution of the same print job, deterioration in image quality may be frequently detected even though there is no change in the apparatus state. In this case, a continuous factor related to hardware, such as degradation of a constituent part, can be identified as one of the causal factors.

In the present embodiment, the user can confirm the history of the image stabilization processing based on the quality management information with a predetermined user interface. The history of the image stabilization processing includes transition and adjustment contents of the image quality.

FIG. 8 is a view illustrating an example of a stabilization processing history screen D. For example, when an operation to display the history of stabilization processing is performed on the operation section 122, the controller 30 allows the display section 121 to display a stabilization processing history screen D. The stabilization processing history screen D may be displayed in real time during execution of the print job.

On the stabilization processing history screen D shown in FIG. 8, the transition D1 of the image density over time is displayed in the form of a graph. Furthermore, the time of occurrence of image quality degradation is indicated in a visually recognizable manner. In FIG. 8, the timing of occurrence of image quality degradation is indicated by a solid line frame D2. In addition, in the stabilization processing history screen D illustrated in FIG. 8, adjustment content D3 of the image formation conditions that has been performed is displayed in text.

Note that regarding the transition D1 of the image density, the period for which the transition is displayed (the horizontal axis in FIG. 8) may be able to be enlarged/reduced and/or scrolled, for example, by operation of the operation section 122. Further, in FIG. 8, the "number of printed sheets" is applied to the horizontal axis, but the "date and time" may be applied instead of the "number of printed sheets".

A user can grasp, from the transition D1 of the image density over time, the tendency of decrease in the image density characteristic. Further, the user can confirm the occurrence time of the image quality deterioration, the print job in which the image quality deterioration has occurred, the adjustment item, and the causal factor by the adjustment content D3. Thus, a user can analyze the causal factor of the image quality degradation and know, for example, whether the degradation is caused by a temporary factor or a continuous factor.

In a case where the image quality is deteriorated due to the continuous factor, it is highly likely that the deterioration of the image quality is temporarily eliminated by the adjustment of the image formation conditions, but the same type of adjustment is performed in a short period of time. In this case, the print job is interrupted for the adjustment of the image formation condition, and the productivity may be reduced. The continuous factor needs to be fundamentally eliminated by replacing a constituent part or the like.

In the present embodiment, since the user can easily know the presence of the continuous factor, the user can appropriately determine the necessity of maintenance. In a case of discovering a continuous factor, the user can take a hardware countermeasure such as replacing a constituent part at an early stage. As a result, the frequency of adjustment of the image forming section 20 due to the continuous factor can be reduced, and productivity is improved.

In FIG. 8, the transition D1 of the image density over time is shown, but the stabilization processing history regarding the image position and the image noise can also be presented to the user in the same manner. For example, regarding the transition of the image position, the vertical axis can indicate the "amount of shift of the image position" and the horizontal axis can indicate the "number of printed sheets" or the "date and time". Furthermore, for example, for the transition of image noise, the vertical axis can represent the "image score" and the horizontal axis can represent the "number of printed sheets" or the "date and time". The image score is an index representing image noise and is expressed by, for example, 0 to 100 points.

As described above, the stabilization processing history screen D may be displayed on the display section 121 of the image forming apparatus 1, or may be displayed on the display section of the external apparatus 4. In the stabilization processing history screen D, pieces of quality management information corresponding to a plurality of image forming apparatuses 1 may be displayable at the same time. In a case where the quality management information corresponding to a plurality of image forming apparatuses 1 is simultaneously displayed, display scales of the graphs indicating the transition of the image quality may be adjusted.

For example, a dedicated application for maintenance and inspection of the image forming system S can be installed in the external apparatus 4, and the stabilization processing history screen D can be displayed in the dedicated application. For example, the controller 30 of each of the plurality of image forming apparatuses 1 is configured to provide the quality management information to the external apparatus 4 in response to a request from the external apparatus 4. Further, for example, the quality management information of a plurality of image forming apparatuses 1 may be provided from a storage on a cloud in response to a request from the external apparatus 4.

As described above, the image forming system S according to the embodiment includes the following features singly or in combination as appropriate.

That is, the image forming system S includes: an image forming section 20 that forms an image on a recording material based on a print job; a reading section 41 that reads the image formed on the recording material; an analyzer that acquires image quality information by analyzing the read image obtained by the reading section 41;an evaluator that evaluates suitability of image quality based on the image quality information; an adjuster that adjusts an image formation condition as necessary; a storage that stores, as quality management information, the image quality information in association with adjustment content of adjustment performed by the adjuster; and a display section 121 that acquires the quality management information from the storage and displays the quality management information. In the embodiment, the controller 30 functions as an "analyzing section/analyzer", an "evaluating section/evaluator", an "adjusting section/adjuster", and a “storage section/storage".

According to the image forming system S, the user can confirm the image quality information and the adjustment content afterward, and analyze and identify the causal factor. Therefore, it is possible to improve the image quality by efficiently eliminating factors that cause deterioration in image quality, particularly continuous factors. In addition, since the user can grasp the presence of a continuous factor and efficiently perform maintenance, productivity is improved.

In the image forming system S, the image quality information includes the variation amount of the image density from a target value, and the controller 30 (adjustment section) adjusts the image formation conditions such that the image density falls within an allowable range. The user can confirm the transition of the image density and the adjustment content, and analyze the causal factor that affects the image density.

In the image forming system S, the image quality information includes the variation amount of the image position on the recording material from a target value, and the controller 30 (adjustment section) adjusts the image formation conditions such that the image position falls within an allowable range. The user can confirm the transition of the image position and the adjustment content and analyze the causal factor that affects the image position.

In the image forming system S, the image quality information includes image noise, and the controller 30 (adjustment section) performs refresh processing for the image forming section 20. The user can confirm the transition (occurrence frequency) of the image noise and the adjustment content and analyze the causal factor that affects the image noise.

In the image forming system S, the controller 30 (storage section) stores the image quality information and the adjustment content in association with the setting content of the print job being executed as the quality management information. Since the user can analyze the causal factor of the image quality degradation in consideration of the setting content of the print job in addition to the image quality information and the adjustment content, accuracy in identifying the causal factor is improved.

In the image forming system S, the controller 30 (storage section) stores the image quality information and the adjustment content in association with the apparatus state information including the installation state and the driving state of the constituent parts as the quality management information. Since the user can analyze the causal factor of the image quality deterioration in consideration of the apparatus state in addition to the image quality information and the adjustment content, the accuracy of specifying the causal factor is improved.

The image forming system S includes the causal factor identification section that identifies the causal factor of the image quality deterioration, and the controller 30 (storage section) stores the identified causal factor in association with the image quality information and the adjustment content as quality management information. In the embodiment, the controller 30 functions as an "causal factor identification section". The user can efficiently analyze the causal factor with reference to the causal factor identified on the system side.

In the image forming system S, the display section of the external apparatus 4 can simultaneously display quality management information corresponding to the plurality of image forming apparatuses 1. Further, in the image forming system S, when the display section of the external apparatus 4 simultaneously displays the quality management information corresponding to the plurality of image forming apparatuses 1, the display scales are adjusted. Accordingly, the image quality of the plurality of image forming systems S can be managed in a unified manner, and maintenance can be efficiently performed.

In the image forming system S, the controller 30 (storage section) stores the quality management information in the storage on the cloud. Thus, the quality management information can be easily acquired from the external apparatus 4 as necessary.

While the invention made by the present inventors has been specifically described based on the preferred embodiment, it is not intended to limit the present invention to the above-mentioned preferred embodiment, but the present invention may be further modified within the scope and spirit of the invention defined by the appended claims.

For example, in the embodiment, the controller 30 of the image forming apparatus 1 functions as the "analysis section (analyzer)" that analyzes the read image, but the function as the "analysis section" may be realized by a controller (not illustrated) of the inspection apparatus 2. In the embodiment, the reading section 41 is installed in the inspection apparatus 2 that is separate from the image forming apparatus 1. However, the reading section 41 may be incorporated in the image forming apparatus 1.

The present invention is also applicable to a monochrome image forming apparatus. Furthermore, the present invention is not limited to an image forming apparatus using an electrophotographic method, but can also be applied to an inkjet printing apparatus.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image forming system, comprising:
an image former that forms an image on a recording material based on a print job;
a reader that reads the image formed on the recording material;
a hardware processor that acquires image quality information by analyzing the read image obtained by the reader, evaluates suitability of image quality based on the image quality information, and adjusts the image former as necessary;
a storage that stores, as quality management information, the image quality information in association with adjustment content of adjustment performed by the adjuster; and
a display that acquires the quality management information from the storage and displays the quality management information.

2. The image forming system according to claim 1, wherein:
the image quality information includes a variation amount of an image density from a target value, and
the hardware processor adjusts an image formation condition such that the image density falls within an allowable range.

3. The image forming system according to claim 1, wherein:
the image quality information includes a variation amount from a target value of an image position on the recording material, and
the hardware processor adjusts an image formation condition such that the image position falls within an allowable range.

4. The image forming system according to claim 1, wherein:
the image quality information includes an image noise, and
the hardware processor performs refresh processing on the image former.

5. The image forming system according to claim 1, wherein
the storage stores, as the quality management information, the image quality information and the adjustment content in association with setting content of the print job being executed

6. The image forming system according to claim 1, wherein
the storage stores, as the quality management information, the image quality information and the adjustment content in association with apparatus state information including an installation state and a driving state of a constituent part.

7. The image forming system according to claim 1, wherein:
the hardware processor identifies a causal factor of image quality degradation, and
the storage stores, as the quality management information, the image quality information and the adjustment content in association with the identified causal factor.

8. The image forming system according to claim 1, wherein
the display is capable of simultaneously displaying the quality management information corresponding to a plurality of image forming apparatuses.

9. The image forming system according to claim 8, wherein
the display adjusts a display scale when the quality management information corresponding to the plurality of image forming apparatuses is simultaneously displayed.

10. The image forming system according to claim 8, wherein
the storage stores the quality management information in a storage on a cloud.
